(19) United States
(12) Patent Application Publication
(10) Pub. No.: US 2017/0249282 A1
(43) Pub. Date: Aug. 31, 2017

(54) CONFIGURABLE PRE-PROCESSING ARRAY

(71) Applicant: Analog Devices, Inc., Norwood, MA (US)

(72) Inventor: Isaac Chase NOVET, Carlsbad, CA (US)

(73) Assignee: Analog Devices, Inc., Norwood, MA (US)

(21) Appl. No.: 15/517,266

(22) PCT Filed: Oct. 6, 2015
(86) PCT No.: PCT/US2015/054265

§ 371 Date: Apr. 6, 2017

Related U.S. Application Data
(60) Provisional application No. 62/061,210, filed on Oct. 8, 2014.

(51) Int. Cl. G06F 15/80; G06F 9/30; G06F 1/32

(52) U.S. Cl. CPC G06F 15/80; G06F 1/32; G06F 9/30

(57) ABSTRACT

A scaled and configurable pre-processor array can allow minimal digital activity while maintaining hard real time performance. The pre-processor array is specially designed to process real-time sensor data. The interconnected processing units of the array can drastically reduce context swaps, memory accesses, main processor input/output accesses, and real time event management overhead.

### RELATED APPLICATION AND PRIORITY APPLICATION

This application is related to, but does not claim priority to, U.S. patent application Ser. No. 13/859,473, filed on Apr. 9, 2013, and entitled “SENSOR POLLING UNIT FOR MICROPROCESSOR INTEGRATION”, which is hereby incorporated by reference in its entirety.

This application claims priority to U.S. Provisional Patent Application 62/061,210, filed on Oct. 8, 2014, and entitled “CONFIGURABLE PRE-PROCESSING ARRAY”, which is hereby incorporated by reference in its entirety.

### TECHNICAL FIELD OF THE DISCLOSURE

The present invention relates to the field of integrated circuits, in particular to configurable pre-processing arrays.

### BACKGROUND

Modern electronic devices, especially portable electronic devices, are often equipped with many sensors. These sensors may include any one or more of the following: microphones, capacitive sensors, light sensors, temperature sensors, multi-axis accelerometers, gyroscopes, global positioning system (GPS) receivers, moisture sensors, pressure sensors, chemical sensors, etc. Examples of such modern electronic devices include tablets, mobile phones, laptops, handheld devices, wearable electronics, etc. Many of these sensors are often acquiring a lot of real time data that a main processor of the electronic device is required to process. Processing real time data using the main processor can take up a lot of computing resources.

### OVERVIEW

A scaled and configurable pre-processor array allows minimal digital activity while maintaining hard real time performance. The pre-processor array is specially designed to process real-time sensor data. The interconnected processing units of the array can drastically reduce context swaps, memory accesses, main processor input/output accesses, and real time event management overhead.

### BRIEF DESCRIPTION OF THE DRAWING

To provide a more complete understanding of the present disclosure and features and advantages thereof, reference is made to the following description, taken in conjunction with the accompanying figures, wherein like reference numerals represent like parts, in which:

FIG. 1 shows an exemplary chip block diagram of a main processor and a configurable pre-processing array, according to some embodiments of the disclosure;

FIG. 2 is a functional diagram illustrating an exemplary H1 processing unit, according to some embodiments of the disclosure;

FIG. 3 is a block diagram illustrating an exemplary interrupt and address generation block, according to some embodiments of the disclosure;

FIG. 4 is a block diagram of a H1 processing unit having a single ALU, according to some embodiments of the disclosure;

FIG. 5 is a block diagram of a H2 processing unit having two ALUs, according to some embodiments of the disclosure; and

FIG. 6 is a block diagram of a H3 processing unit having three ALUs, according to some embodiments of the disclosure; and

FIG. 7 is a flow diagram illustrating a method for preprocessing real time sensor data streams, according to some embodiments of the disclosure.

### DESCRIPTION OF EXAMPLE EMBODIMENTS OF THE DISCLOSURE

Power Consumption Issues for Processing Real Time Sensor Data

When a main processor of an electronic device is processing many streams of real time sensor data, the main processor consumes a great deal of power, and also, available resources would be taken away from other processes on the main processor. Many modern electronic devices have limited power resources (e.g., due to the battery), or even when these electronic devices are plugged in, the power requirements of the electronic devices during sleep or standby mode can be very strict for power efficiency reasons. At the same time, applications are often “always on”, especially applications which are always sensing the environment or the state of the electronic device. These applications often require the main processor to constantly process the real time data from these sensors.

Such computing architecture has many inefficiencies. One inefficiency is the load and store aspect of gathering sensor data and storing the data in memory, which accounts for a substantial amount of processing. Another inefficiency relates to performing register transactions for a communication interface (e.g., serving synchronous reads of sensor data). A further inefficiency relates to context switching in the main processor, which is often running many different applications having different contexts (and context switching can cause jitter in the user experience). The main processor halting a process and switching to another process (involving memory shuffling) when switching between contexts can often lead to inefficient processing of sensor data.

Solution: Configurable Pre-Processing to Assist the Main Processor

In portable consumer devices, the conservation of energy is one of several factors contributing to the overall user experience. Simultaneously, the continuous or constant collection and interpretation of various forms of sensor data form the foundation of how the portable device operates and interacts with the user and the environment. An ideal scenario would include sensor data being constantly being sampled and pre-processed while very little power is consumed.

To address the issue of power consumption, an improved computing architecture leverages a specialized configurable pre-processing array designed specifically to process sensor data from a plurality of sensors (e.g., many streams of real time sensor data). The specialized configurable pre-processing array can include digital circuits for processing digital data. The array can be integrated with circuitry which interfaces with sensors (e.g., analog front ends to perform “light” processing). When the sensors, analog front end, and the configurable pre-processing array are provided together as a sensing sub-system, the sensing sub-system can gather sensor data and perform intelligent operations on sensor data while consuming little power.

A unique feature of the configurable pre-processing array is its segmentation of processing responsibilities into task-optimized processing units, and by the seamless interaction between processing units via a configurable network of interconnects between these processing units. Overhead is minimized through cooperative processing in the pipeline configuration without frequent context switching in the main processor. The synchronous collection of data is performed in such a way that there is nearly no processing performed which does not contribute to the end goal of gathering and preparing data for the next stage (almost all processing performed contribute to the end goal of gathering and preparing data for the next stage). Also, the interactions between pipelines incur zero overhead. Because the configurable pre-processing array can be implemented in asynchronous logic (operating asynchronously without a shared or global clock signal among the processing units), a very minimal number of gates would transition, leading to minimal dynamic power. The strength of the system is that at an instruction level the number of items to be performed is pared down to a minimum, which has an advantage of lowering overall power consumption.

The solution preferably performs any one or more of the following technical tasks. A first exemplary technical task is to continuously gather sensor data while the majority of the system is shut down with acceptably low power consumption. A second exemplary technical task is to identify areas of interest in sensor data streams before waking the main processor or other resources. A third exemplary technical task is to perform acquisition and pipelined processing of sensor data after the main processor is awake. A fourth exemplary technical task is to allow the main processor to dynamically reconfigure microcode of underlying processing units to suit the needs of the system (hardware threading). A fifth exemplary technical task is to provide a simplified implementation of algorithms by allowing the use of (graphical) development tool to generate microcode.

Matrix of Interconnected Arithmetic Logic Units (ALUs) Organized in Layers

A main processor can trigger processes that would selectively activate parts the configurable pre-processing array, a matrix of interconnected arithmetic logic units (ALUs), to constantly monitor sensors. The matrix of interconnected ALUs can be organized as asynchronous processing units arranged in multiple processing layers. Different flavors of processing units with varied complexity are selectively feature limited, and are arranged in parallel pipelines so that that sensor data can be evaluated by pipeline stages only to the point that it is determined to be useful or not useful. Generally speaking, the lower processing layer would have processing units of lower complexity when compared to the processing units of higher processing layers.

For instance, interfaces to the sensors can be serviced by processing units having a basic (single) ALU (the quantum of the pipeline). At higher layers, processing units can have two or more ALUs, and the interconnects of these processing units (e.g., data routing) can facilitate joining and branching of dynamic pipelines. Because the processing units are not clocked, i.e., the units are asynchronous, power consumption can be reduced significantly, especially in low leakage processes.

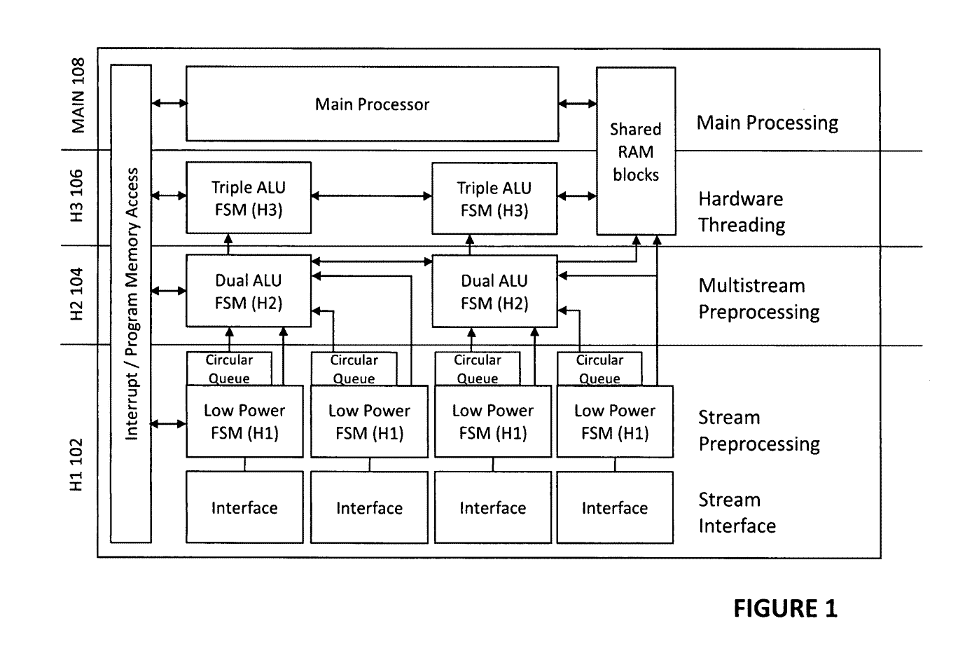

FIG. 1 shows an exemplary chip block diagram of a main processor and a configurable pre-processing array, according to some embodiments of the disclosure. In this example, the chip block diagram shows H1 layer 102, H2 layer 104, H3 layer 106, and a main processing layer 108. The H1 layer 102, H2 layer 104, and H3 layer 106 are associated with processing of the configurable pre-processing array. The main processing layer 108 is associated with processing of the main processor. It is understood that less or more layers can be provided depending on the application. Furthermore, the example shows a number of processing units per layer, but it is understood that less or more units can be provided per layer depending on the application. A main processor manages the configuration of the pre-processing pipelines through suitable instructions that these processing units are capable of executing. The configuration can dictate, e.g., how data is moved through the layers (in between processing units of each layer, or between processing units of different layers).

In some embodiments, a configurable pre-processing array can perform pre-processing of real time sensor data streams and reduce reducing power consumption of an overall system. The configurable pre-processing array is implemented with specialized circuitry whose execution of operations can be programmable. The configurable pre-processing array includes a plurality of first processing units in a first processing layer (H1 layer 102) for processing real time sensor data streams. Each one of the first processing units can be configured to execute one or more first processing layer instructions from a main processor. The configurable pre-processing array also includes a plurality of second processing units in a second processing layer (H2 layer 104) for processing output data generated by the first processing layer (H1 layer 102). Each one of the second processing units can be configured to execute one or more second processing layer instructions from the main processor. The instruction set can vary depending on the application. Many of these processing units can operate in parallel as multiple pipelines. Accordingly, the processing of many real time sensor data streams can be performed very efficiently.

If desired, the configurable pre-processing array can also include further processing layers. For instance, the configurable pre-processing array can include a plurality of third processing units in a third processing layer (H3 layer 106) for processing output data generated by the second processing layer (H2 layer 104). Each one of the third processing units can be configured to execute one or more third processing layer instructions from the main processor.

Besides the operations performed by the processing units, the routing of data between different parts of configurable pre-processing can also be programmable, e.g., by the main processor. In some cases, the main processor can specify conditional data routing, where the data routing is conditioned on the output data of processing units. Conditional data routing allows for complex data processing by the configurable processing array, e.g., intelligent sensing based on data from multiple sensors. Moreover, conditional data routing advantageously allows pipelines to join or split depending on the sensor data.

For instance, a first one of the second processing units may include circuitry providing conditional data routing to one or more of the following: memory, a peer second processing unit (in the second processing layer), and a processing unit at a third processing layer. In some cases, the conditional data routing, i.e., where the output data of the first one of the second processing units should be routed, can be based on output data of the first one of the second processing units.

In some instances, a first one of the third processing units may include circuitry providing conditional data routing to one or more of the following: memory, a peer third processing unit (in the third processing layer), and a processing unit at a third processing layer. In some cases, the conditional data routing, i.e., where the output data of the first one of the third processing units should be routed, can be based on output data of the first one of the third processing units.

Advantages of the Parallel Processing of Sensor Data Streams

A single sensor can be served by a pipeline which begins at the interface block in H1 layer 102. Multiple sensors can thus be handled by multiple interface blocks in the H1 layer 102 via respective pipelines. These pipelines provide parallel processing of multiple streams of data, and these pipelines can be merged or split depending on the programming of the configurable processing array. Specifically, the microcoded configuration of the pipeline can program the pipelines to periodically collect sensor data, programmatically evaluate sensor data, evaluate the data received from the merger of multiple pipelines, evaluate data split from pipelines, turn on processing units with varying levels of processing complexity, and at the highest levels of functionality, perform loop acceleration or parallelization tasks for the main processor. Due to the configurability of the dynamic pipeline, results of the operations can be shared and diverted to other processing units to leverage the highly parallel architecture.

The stages are also provided with some advantageous features to provide efficient processing of sample data without the interference of the main processor. For instance, some stages of a pipeline can implement a loop and/or branching function, depending on the position in the pipeline (usually applicable for processing units in the higher layers). Each stage can implement zero overhead looping, which can greatly increase efficiency without the intervention or work performed by the main processor. Some stages can even perform zero cycle jump, interrupt, and return. In another instance, some stages in the pipeline can directly pass data to the next stage, eliminating data memory accesses during the transition, as well as reducing function call or potential process context swaps. The passing of output data can be done between “peer” processing units in the same layer, or from one processing unit of one layer to another processing unit of a higher layer. In a further instance, these processing units can also write to shared memory without the interference from the main processor. The configurable-pre-processing array can include a shared memory accessible by the first processing layer, the second processing layer, and the third processing layer without interference from the main processor. The shared memory can be used for inter-processing-layer communication of data, without having to utilize cycles or resources of the main processor.

The H1 (Lowest) Layer: The Quantum of the Configurable Processing Array

The H1 layer 102 seen in FIG. 1, being the lowest layer of processing, has a limited implementation. The H1 layer 102 has individual pipelines for each sensor, where each pipeline includes an interface block (e.g., a respective sensor interface) and a low power finite state machine (FSM) block (referred herein as a “H1 processing unit”, which can include a single arithmetic logic unit for processing sensor data). For instance, one interface block can interface with an accelerometer via a serial interface, and another interface block can interface with a capacitive sensor via another serial interface. Broadly speaking, this layer is “always on”. Specifically, the layer is configured to gather and store sensor data, and in many cases, implement simple stream monitoring to indicate activity of interests. For instance, thresholding is a common stream monitoring function.

In some embodiments, a first processing unit in a first processing layer (H1 layer 102) can monitor a real time sensor data stream by applying a threshold to the real time sensor data stream. For instance, the first processing unit can check whether data values in the real time sensor data stream is greater than the threshold, or check whether a minimum number of data values have exceed the threshold. If so, the first processing unit has detected activity of interest. This mode of operation is particularly advantageous since sensors can be “dormant” or have no interesting activity for long periods of time. Without this layer of processing, the main processor would expend a lot of energy to poll the sensor for activity of interest.

One of the technical tasks performed by H1 layer 102 is to manage synchronous collection of data from an arbitrary data interface, perform mild pre-processing if required, and to consume as little power as possible. For instance, the rest of the system is kept “off” or “unoccupied” while the H1 layer 102 can scan for activity of interest in sensor data and interrupt the higher layer (e.g., H2 layer 104) if activity of interest is found. Typically, guaranteeing hard real time sampling of multiple sensors begins to be a challenge for a single processor under any significant amount of load. Also, it is power inefficient for the large mechanism of a processor to sample an external sensor regularly. The H1 layer 102 addresses these issues by performing only a single-shot loop to capture data from a sensor upon being triggered to do so, processing the received data if required, and then stalls until another the main processor triggers another single-shot loop. In some embodiments, at least one of the first processing units of the first processing layer (H1 layer 102) can be configured to perform a single-shot execution of instructions in an instruction memory in response to an enable signal and stall after the execution of the single shot execution of instructions until another enable signal is triggered.

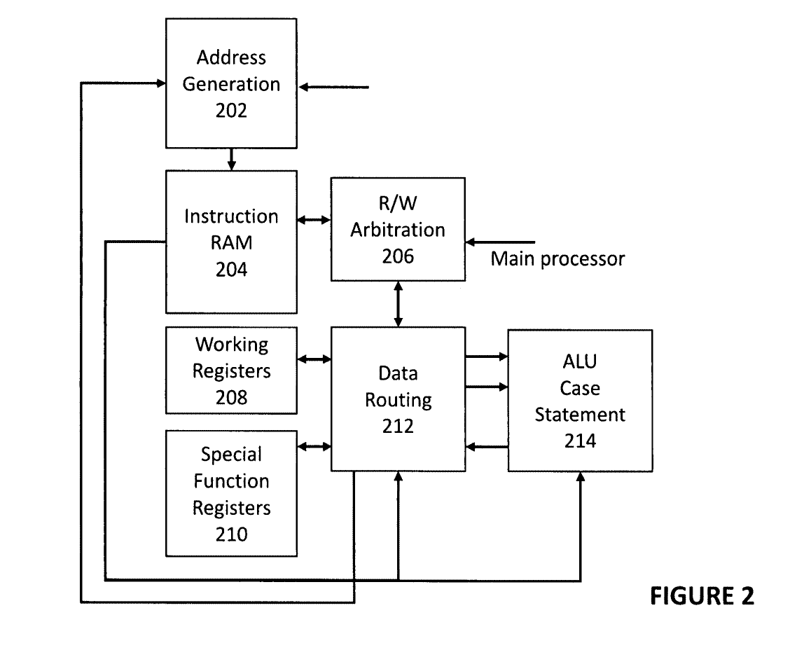

FIG. 2 is a functional diagram illustrating an exemplary H1 processing unit, according to some embodiments of the disclosure. The functional blocks of the H1 processing unit includes an address generator block 202, instruction random access memory (RAM) 204, read/write (R/W) arbitration block 202, working registers 208, special function registers 210, data routing 212, and ALU case statement block 214. To trigger a single-shot loop (a “loop” that only iterates once), the main processor can load instructions (“microcode”) onto the instruction RAM 204 via the R/W arbitration block 206 and cause an enable signal to be provided to address generation block 202. The address generation block 202 can include circuitry that can sequentially execute the instructions in the instruction RAM 204 in response to the enable signal.

The H1 processing unit can be considered as a basic processor with a single interrupt vector. The H1 stalls after completing the instructions in the interrupt service routine, consuming no dynamic power. Any source capable of maintaining a time base is suitable for triggering the H1's enable signal; examples are digital counters, oscillating analog comparator circuits, and so on. Preferably, the H1 is implemented as asynchronous logic. The H1 processing unit may gate its own clock when processing is complete (e.g., gates a clock or signal of the asynchronous logic when the execution of the one or more first processing layer instructions is complete).

Portion of an instruction can control data routing, such as controlling multiplexers to load proper operands from working registers 208 and special function registers 210 and to write data to working registers 208 and special function registers 210. Furthermore, portion of each instruction can select an appropriate ALU function in the ALU case statement 214 block for processing the data. Working registers 208 are generally used for storing intermediate results of the instructions, and special function registers 210 are generally used for communicating data to/from blocks outside of the H1 processing unit (e.g., sensor interface, memory of the main processor, a circular buffer to the next stage in the pipeline, a register for the next stage in the pipeline, etc.). The ALU case statement block 214 would generally include a minimal instruction set, such as instructions which are optimized for finite impulse response (FIR) filtering and comparison, or other instructions which can execute mild pre-processing of sensor data. Once finished with the instructions of the instruction RAM 204, the address generation block 202 can reset and go back to zero (i.e., the beginning of the instruction RAM 204).

Use of a Circular Queue at the Output of a Pipeline Stage

Referring back to FIG. 1, a circular queue can be provided to store samples of interest, or data generated by a processing unit at any one of the processing layers so a higher layer can read data in burst mode. In some embodiments, the first processing layer (H1 layer 102) further comprises a circular queue at an output of (any) one of the first processing units, wherein one of the second processing units fetches the output data directly from the first processing layer via the circular queue. Other processing units of other layers (e.g., H2 and H3) can include a circular queue at the output as well.

The circular queue is distinguished from the direct path, because the circular queue allows a burst read of multiple data samples and the direct path only allows a read of a single data sample. The example shows a circular queue at the output of the H1 processing unit, but it is understood that other processing units at higher layers can also include the circular queue (between processing units of different layers or between “peer” processing units of the same layer). Advantageously, some processing requiring a plurality of data samples (e.g., Fast Fourier Transform) can read multiple data samples quickly through the queued path. The circular queue allows a processing unit to store data in the queue without any no load and store to memory. The circular queue is effectively a pipeline delay operation, which is far more efficient than actual memory accesses.

Interrupt and Address Generation

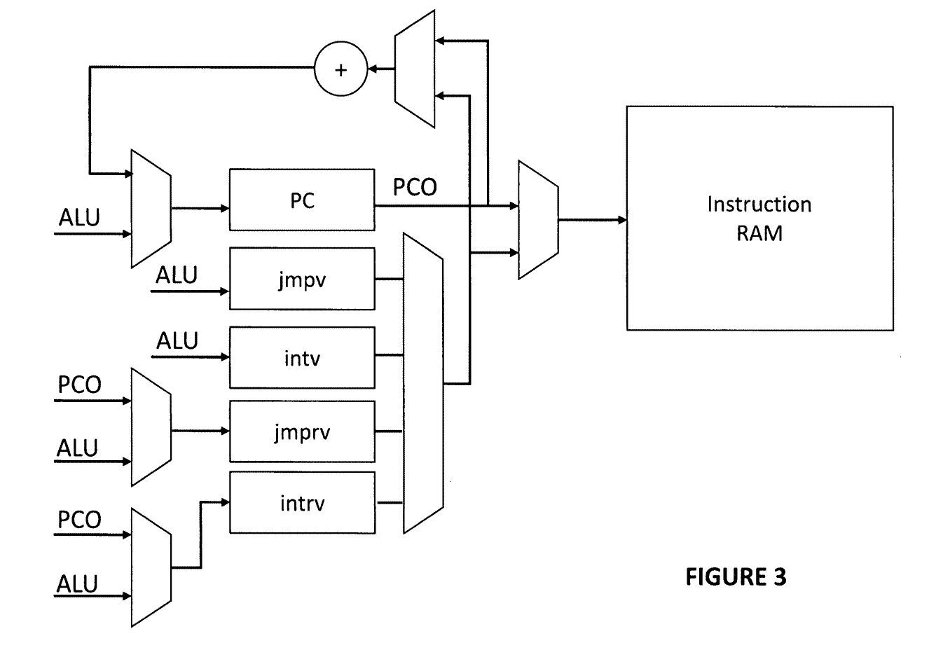

The implementation of the single-shot loop is rather simple. For higher layers of processing such as the H2 layer 104 and the H3 layer 106, further circuitry can be provided in the address generation block of a processing unit to provide more complex processing of sensor data streams. The additional circuitry can provide of zero cycle jump, interrupt, and return, and also provide zero latency looping using a loop counter. FIG. 3 is a block diagram illustrating an exemplary interrupt and address generation block, according to some embodiments of the disclosure. The more complex address generator shown can store interrupt, jump, and return vectors (“jmpv”, “intv”, “jmprv”, and “intrv”) in the registers that a program counter (“PC”) can use for generating the program counter “PCO”. ALU may also write to the program counter itself. Such an interrupt and address generator can provide more flexible jumping than the single-shot loop execution of the H1 processing layer.

Various Build Configurations for ALU(s) in a Processing Unit

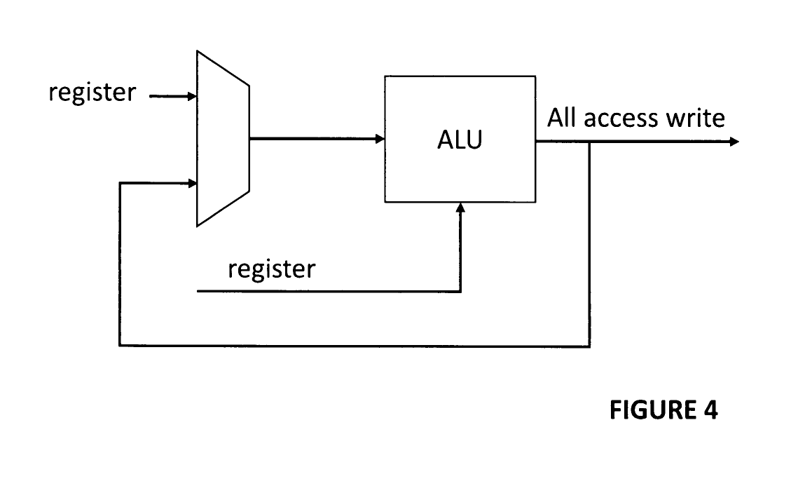

Referring back to FIG. 1, the different layers of processing have processing units of varying complexities. At the H1 layer 102, the low power FSM processing unit has one ALU. FIG. 4 is a block diagram of a H1 processing unit having a single ALU, according to some embodiments of the disclosure. Single ALU processing units can be tasked with basic gathering and first in first out (FIFO) tasks. To provide more complex processing of data streams, the higher layers have processing units that have more than one ALU. One to three (or more) ALUs can be combined into a processing unit. In some embodiments, at least one of the one or more first processing units (in H1 layer 102) each have a single arithmetic logic unit, at least the one or more second processing units (in H2 layer 104) each have two arithmetic logic units. In some cases, at least one of the third processing units each has three arithmetic logic units.

Dual ALU FSM Processing Unit at the H2 Layer

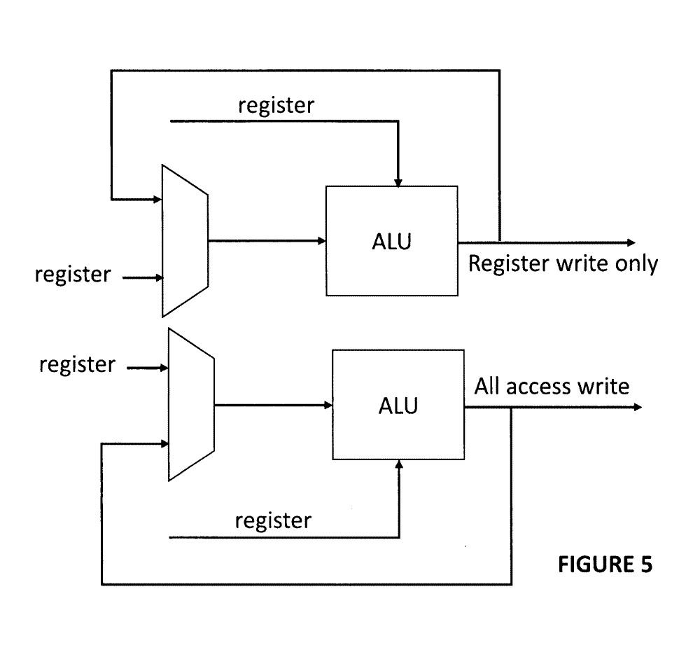

Dual ALU FSM at H2 layer 104 can have two ALUs. Dual ALU FSM processing units can be good for comparison and analysis of two data streams. FIG. 5 is a block diagram of a H2 processing unit having two ALUs, according to some embodiments of the disclosure. This processing unit can be used at the H2 layer, which can provide complex recognition. The H2 layer corresponds to H2 layer 104 of FIG. 1, which includes one or more dual ALU FSM (referred herein as a “H2 processing unit”). It can be seen from the FIGURE that the two ALUs can process two streams of data simultaneously. Joining and splitting the streams are also possible. The H2 processing unit is designed to be able to take either 0, 1, or 2 data sources and determine the routing of the data. The H2 processing stalls until it has received the appropriate interrupt signal or trigger signal, which can be a synchronous (interrupt) source or trigger or one or more H1 data ready interrupt signals. The H2 takes the data present on its inputs and may inspect previous samples or other data stored in memory to determine if the next stage of the pipeline should be activated. The decision process can pre-process data for the next stage.

The instructions for this processing unit can advantageously provide a conditional routing based on the data to determine whether the output data should be routed to memory, a peer H2 processing unit, or a H3 processing unit (or any combination thereof). This important feature, the dynamic pipeline is based on the conditions of the data, enables multiple algorithms (pipelines) to take advantage of the same processing being performed by a particular processing block. Furthermore, processing or operations on data can be shared between different contexts (i.e., sharing intermediate results by joining or branching data outputs) without the overhead of context switching, so long the instructions have programmed the configurable processing array properly.

Generally speaking, the Dual ALU FSM processing units in H2 layer can perform more complex analysis of data after H1 has detected interesting activity. When there is no interesting activity in the lower H1 layer, the processing units in H2 layer sleeps/stalls until activity is detected in H1 layer. The processing units in H2 layer can investigate activity of interest in sensor data, and process moderate complexity algorithms on multiple data streams in parallel. The code for the Dual ALU FSM is compatible with the single ALU FSM, where internals change to two ALUs and a write destination semaphore. Such code can be generated in a macro language or other suitable programming tool.

Treble ALU FSM Processing Unit at the H3 Layer

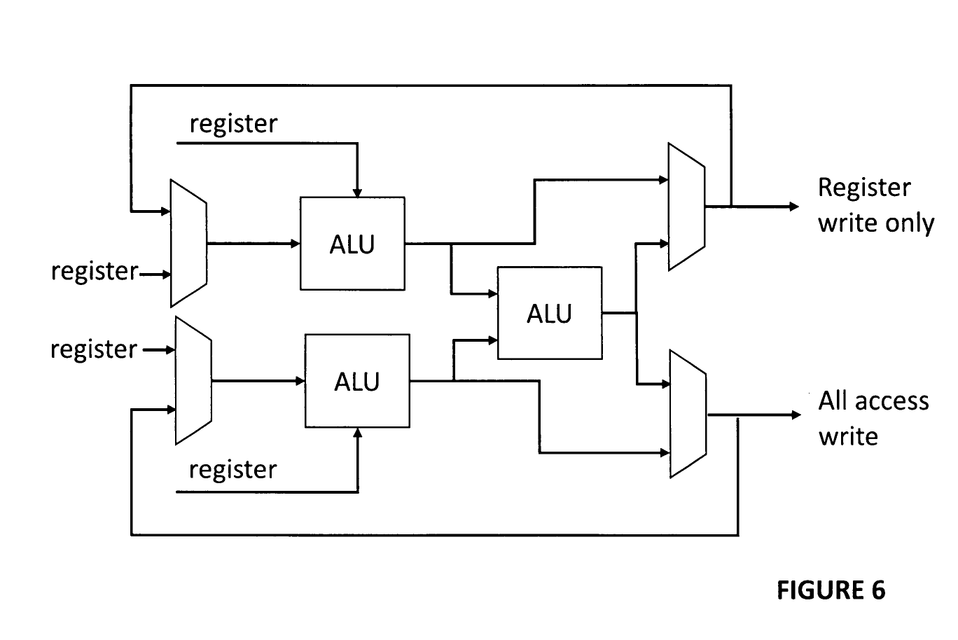

Treble ALU FSM at H3 layer 106 can have three ALUs. The H3 layer corresponds to H3 layer 106 of FIG. 1, which includes one or more dual ALU FSM (referred herein as a “H3 processing unit”). The processing units in this layer sleeps until valid lower layer activity or other event occurs. The Treble ALU processing units can be good for taking over main processor computational tasks as hardware threads. FIG. 6 is a block diagram of a H3 processing unit having three ALUs, according to some embodiments of the disclosure. The third and final stage in the pipeline, the H3 processing block, is designed to implement small algorithms requiring hard real time performance. By having three ALUs, the H3 processing unit can join and branch data streams. With the internal merge function (joining the outputs of two ALUs), the H3 processing unit obviates the need to use 1.5 H2 processing units.

Examples of tasks performed by the H3 processing unit can include proportional-integral-derivative (PID) loops, haptic feedback, and augmented audio functions. This stage of the pipeline can provide real time performance to algorithms and to allow the main processor to control operational parameters in soft real time through a high level application programming interface (API). This could allow further abstraction of sensors and algorithms by implementing certain algorithms as microcode for the pipeline stages. The result is a layer of processing which can assist the main processor with periodic processing tasks while in full operation. The code for the H3 layer is generally compatible with H1 and H2 layers, and the main processor can use the H3 unit as a hardware thread, either loading a binary generated in a programming tool, or by directly loading generated bytecode on the fly.

Software for Configuring the Pre-Processing Array

In some embodiments, the varied flavors of processing units are downwards compatible, meaning a dual unit could run the code of a single unit, etc. Single programming model can be provided for all the flavors of processing units, and thus any missing functionality can be emulated easily. Code space can be limited. Note that a profiling tool can be used to generate the microcode for configuring the pre-processing array to optimize reuse of processing units and parallelism.

The Configurable Pre-Processing Array is Distinguishable from a Generic Coprocessor

In some systems, a high performance, main processor is usually assisted by co-processors, e.g., graphics processors, audio processors, generic small co-processors, etc. One example of this may be the inclusion of generic small-sized processor alongside a main/applications processor in an electronic device to provide some data communication functions for a communication interface. These co-processors are usually overly capable, and not particularly suitable for processing streams of sensor data. While there are many reasons for using standard co-processors, such as familiarity with existing tool chains and IP, using generic co-processors does not reap the same benefits as a processing network specifically targeted towards processing sensor data.

Method for Pre-Processing Real Time Sensor Data Streams

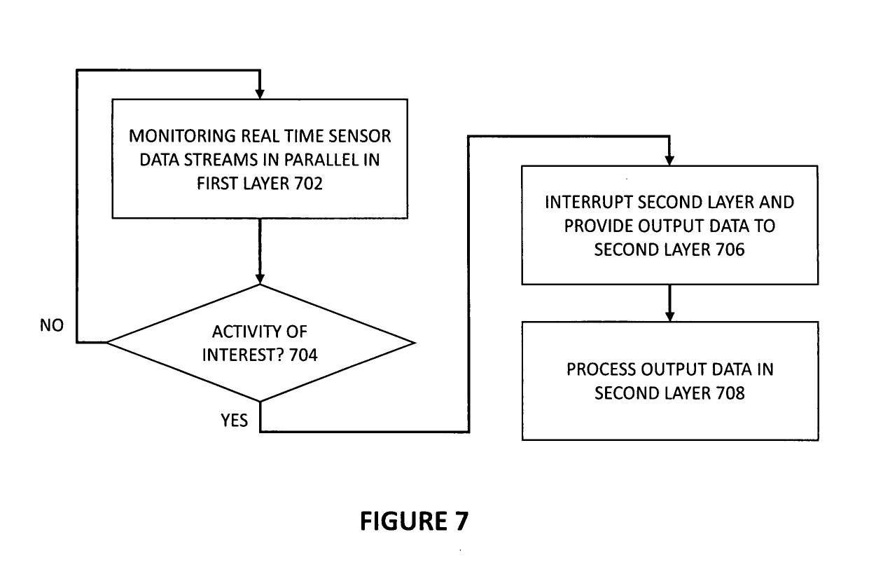

FIG. 7 is a flow diagram illustrating a method for preprocessing real time sensor data streams, according to some embodiments of the disclosure. The method for pre-processing real time sensor data streams can advantageously reduce context switching of a main processor. A plurality of first processing units in a first processing layer (H1) of a configurable pre-processing array monitors real time sensor data streams from a plurality of sensors in parallel according to one or more first processing layer instructions from the main processor (task 702). For instance, the first processing units can individually and in parallel, monitor for activity of interest in the data streams. In response to detecting activity of interest in the real time sensor data streams by a first one of the first processing units (check 704), the first one of the first processing unit can interrupting a second processing unit (task 706) in a second processing layer (H2) and provide output data from the first one of the first processing units to the second processing unit in the second processing layer (task 708).

In some embodiments, monitoring the real time sensor data streams (task 702) comprises applying a threshold to at least one of the real time sensor data streams. In some embodiments, monitoring the real time sensor data stream applies a filter (e.g., specified by the main processor) to the real time sensor data stream such that a filtered version is provided to the second processing layer (H2) for further processing.

In some embodiments, processing the output data from the first one of the first processing units by a first one of the second processing units according to one or more second layer processing instructions from the main processor. For instance, the first one of the second processing units can “wake up”, and two ALUs in the first one of the second processing units can operate on the output data from the first one of the first processing units.

To provide complex processing of the sensor data streams, the method can include routing output data of the first one of the second processing units conditionally by a first one of the second processing units (in H2) to one or more of the following: memory, a peer second processing unit (in H2), and a processing unit at a third processing layer (H3), based on output data of the first one of the second processing units.

To conserve power, the method includes stalling one or more ones of the second processing units until one or more ones of first processing units detect activity of interest in the sensor data streams. The method can further include stalling one or more ones of the third processing units until one or more ones of second processing units detect activity of interest in the data.

Applications, Variations, and Implementations

In certain contexts, the features discussed herein can be applicable to consumer (portable) devices, medical systems involving sensors, scientific instrumentation involving many sensors, wireless and wired communications, radar involving sensors/receivers, industrial process control involving sensors, audio and video equipment involving sensors, instrumentation involving sensors, and other digital-processing-based systems having many sensors generating many streams of sensor data. Broadly speaking, the embodiments described herein is applicable in many applications where monitoring of sensor data is needed while not consuming a lot of power. The configurable pre-processing array is typically used to assist a main processor in processing sensor data streams. The array, the main processor, can be coupled to a battery-powered device which has limited power resources. In such scenarios, the configurable pre-processing array is particular advantageous because it can enable continuous monitoring of sensor data streams while using very little power.

Besides portable electronics, the embodiments disclosed herein are also applicable in systems where the sensors are distributed remotely from the main processor and the configurable pre-processing array. One example is the use of the disclosed embodiments with Internet of Things. In Internet of things, many sensors (uniquely identifiable sensing devices) can be communicably connected to the configurable pre-processing array. Sensor data can be provided via the interface (as seen in the H1 layer) as frames or packets of data, where the interface to the sensors in the H1 layer can include a communication interface, e.g., a wireless communication interface. The H1 processing unit can be used for minimal network frame or packet processing, such as decapsulation of frames/packets (e.g., processing and/or removing header information), data computations related to checksum, other network layer processing. Effectively, the main processor is alleviated from having to perform these network-related functions, and the H1 processing units may activate higher layers of the configurable pre-processing array to further process the incoming data from the sensors (such as processing the payload content, detecting activity of interest in the payload content, or other suitable application processing).

Broadly speaking, the embodiments disclosed herein are applicable to systems where data from many transmitting devices are being monitored. Any one or more of these devices can be local to the main processor and the configurable pre-processing array (e.g., via a wired interface), or be remote from the main processor and the configurable pre-processing array (e.g., via a wired or wireless interface). These devices can include monitoring devices used in, e.g., the health care industry, farming/agricultural industry, automobile industry, transportation industry, sports industry, people tracking, inventory tracking, security industry, etc. For some applications, these devices can include low-power radios capable of transmitting data to the interface at the configurable pre-processing array. In many of these applications, the data can include sensor data, or data which samples the state of the sensor (e.g., “alive” status, “idle” status, or “active” status). For instance, an application that is monitoring the status of many devices can leverage the configurable pre-processing to lower the main processor's power consumption. In these applications, the application may periodically or frequently poll the status of these devices, and/or the devices may periodically or frequently transmit status to the main processor. To decrease power consumption, the polling, receipt, and processing of status information for these devices can easily be implemented in the configurable pre-processing array. The processing units may also be configured to detect activity of interest in the status originating from one device. The processing units with more complexity for merging pipelines (in some cases conditionally) can also be configured to activity of interest in statuses originating from many devices, making way for more complex recognition or activity detection.

In some embodiments, a method for pre-processing real time sensor data streams from networked sensors comprises receiving, at a configurable pre-processing array assisting a main processor, frames or packets comprising real time sensor data streams originating from a plurality of sensors. A plurality of first processing units in a first processing layer (H1) of the configurable pre-processing array can perform network layer processing on the frames or the packets, by providing the real time sensor data streams from the first processing units to a plurality of second processing units in a second processing layer (H2) of the configurable pre-processing array. The second processing units can process the real time sensor data streams for activity of interest. Each one of the second processing units can execute one or more second processing layer instructions from a main processor. In response to detecting activity of interest in the real time sensor data, one or more of the second processing units can interrupt at least one of the third processing units in a third processing layer (H3) and providing output data of the second processing layer to the at least one of the third processing units.

Note that the activities discussed above with reference to the FIGURES are applicable to any integrated circuits that involve signal processing, particularly those that can execute specialized software programs, or algorithms, some of which may be associated with processing digitized real-time (sensor) data. Certain embodiments can have a main processor which relates to multi-DSP signal processing, floating point processing, signal/control processing, fixed-function processing, microcontroller applications, etc.

In the discussions of the embodiments above, the processing units, function blocks, capacitors, clocks, DFFs, dividers, inductors, resistors, amplifiers, switches, digital core, transistors, and/or other components can readily be replaced, substituted, or otherwise modified in order to accommodate particular circuitry needs. Moreover, it should be noted that the use of complementary electronic devices, hardware, software, etc. offer an equally viable option for implementing the teachings of the present disclosure.

Parts of various apparatuses for providing configurable pre-processing of sensor data can include electronic circuitry to perform the functions described herein. In some cases, one or more parts of the apparatus can be provided by a main processor specially configured for triggering the functions described herein. For instance, the processor may include one or more application specific components, or may include programmable logic gates which are configured to trigger the functions describe herein. The circuitry can operate in analog domain, digital domain, or in a mixed signal domain. In some instances, the main processor may be configured to trigger the configurable pre-processing array to carry out the functions described herein by executing one or more instructions stored on a non-transitory computer medium.

In one example embodiment, any number of electrical circuits of the FIGURES may be implemented on a board of an associated electronic device. The board can be a general circuit board that can hold various components of the internal electronic system of the electronic device and, further, provide connectors for other peripherals. More specifically, the board can provide the electrical connections by which the other components of the system can communicate electrically. Any suitable processors (inclusive of digital signal processors, microprocessors, supporting chipsets, etc.), computer-readable non-transitory memory elements, etc. can be suitably coupled to the board based on particular configuration needs, processing demands, computer designs, etc. Other components such as external storage, additional sensors, controllers for audio/video display, and peripheral devices may be attached to the board as plug-in cards, via cables, or integrated into the board itself.

In another example embodiment, the electrical circuits of the FIGURES may be implemented as stand-alone modules (e.g., a device with associated components and circuitry configured to perform a specific application or function) or implemented as plug-in modules into application specific hardware of electronic devices. Note that particular embodiments of the present disclosure may be readily included in a system on chip (SOC) package, either in part, or in whole. An SOC represents an IC that integrates components of a computer or other electronic system into a single chip. It may contain digital, analog, mixed-signal, and often radio frequency functions: all of which may be provided on a single chip substrate. Other embodiments may include a multi-chip-module (MCM), with a plurality of separate ICs located within a single electronic package and configured to interact closely with each other through the electronic package. In various other embodiments, the configurable pre-processing array may be implemented in one or more silicon cores in Application Specific Integrated Circuits (ASICs), Field Programmable Gate Arrays (FPGAs), and other semiconductor chips.

It is also imperative to note that all of the specifications, dimensions, and relationships outlined herein (e.g., the number of processors, logic operations, etc.) have only been offered for purposes of example and teaching only. Such information may be varied considerably without departing from the spirit of the present disclosure, or the scope of the appended claims. The specifications apply only to one non-limiting example and, accordingly, they should be construed as such. In the foregoing description, example embodiments have been described with reference to particular processor and/or component arrangements. Various modifications and changes may be made to such embodiments without departing from the scope of the appended claims. The description and drawings are, accordingly, to be regarded in an illustrative rather than in a restrictive sense.

Note that with the numerous examples provided herein, interaction may be described in terms of two, three, four, or more electrical components. However, this has been done for purposes of clarity and example only. It should be appreciated that the system can be consolidated in any suitable manner. Along similar design alternatives, any of the illustrated components, modules, and elements of the FIGURES may be combined in various possible configurations, all of which are clearly within the broad scope of this Specification. In certain cases, it may be easier to describe one or more of the functionalities of a given set of flows by only referencing a limited number of electrical elements. It should be appreciated that the electrical circuits of the FIGURES and its teachings are readily scalable and can accommodate a large number of components, as well as more complicated/sophisticated arrangements and configurations. Accordingly, the examples provided should not limit the scope or inhibit the broad teachings of the electrical circuits as potentially applied to a myriad of other architectures.

Note that in this Specification, references to various features (e.g., elements, structures, modules, components, steps, operations, characteristics, etc.) included in “one embodiment”, “example embodiment”, “an embodiment”, “another embodiment”, “some embodiments”, “various embodiments”, “other embodiments”, “alternative embodiment”, and the like are intended to mean that any such features are included in one or more embodiments of the present disclosure, but may or may not necessarily be combined in the same embodiments.

It is also important to note that the operations for processing sensor data described herein illustrate only some of the possible processes that may be executed by, or within, systems illustrated in the FIGURES. Some of these operations may be deleted or removed where appropriate, or these operations may be modified or changed considerably without departing from the scope of the present disclosure. In addition, the timing of these operations may be altered considerably. The preceding operational flows have been offered for purposes of example and discussion. Substantial flexibility is provided by embodiments described herein in that any suitable arrangements, chronologies, configurations, and timing mechanisms may be provided without departing from the teachings of the present disclosure.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. Note that all optional features of the apparatus described above may also be implemented with respect to the method or process described herein and specifics in the examples may be used anywhere in one or more embodiments.

### ILLUSTRATIVE EMBODIMENTS

Example 1 is a configurable pre-processing array for performing pre-processing of a plurality of sensor data streams, the array comprises: a first processing layer for processing sensor data streams, the first processing layer having one or more first processing units connected to a plurality of sensor interfaces, at least one of the one or more first processing units having a single arithmetic logic unit (ALU); and a second processing layer for processing output data from the first processing layer, the second processing layer having one or more second processing units, at least the one or more second processing units having two ALUs; wherein a first one of the second processing units comprises circuitry providing conditional data routing, based on the output data of the processing unit, to one or more of the following: memory, a peer second processing unit, and a processing unit at a third processing layer.

In Example 2, the array of Example 1 can include the third layer comprising one or more third processing units, each one or more third processing units having three ALUs.

In Example 3, the array of Example 1 or 2, can include a circular queue at an output of one of the first processing units (or other processing units at other processing layers).

In Example 4, the array of any one of the above Examples can include the one or more first processing units being configured to perform a single-shot execution of instructions in a loop in response.

In Example 5, the array of any one of the above Examples can include at least one of the one or more second processing units comprising an interrupt and address generator for storing interrupt, jump, and return vectors in registers that a program counter uses for generating the program counter.

In Example 6, the array of any one of the above Examples can include at least one of the one or more second processing units comprises an interrupt and address generator having a program counter that is programmable by the output of an ALU of the second processing unit.

In Example 7, the array of any one of the above Examples can include the array being coupled to a plurality of sensors via a serial interface.

In Example 8, the array of any one of the above Examples can include the array being coupled to a battery-powered device.

In Example 9, the array of any one of the above Examples can include the one or more second processing units stall until the one or more first processing units detect activity of interest.

In Example 10, the array of any one of the above Examples can include one or more third processing units of the third layer stall until the one or more second processing units detect activity of interest.

In Example 11, the array of any one of the above Examples can include the array operating asynchronously (without a clock).

1. A configurable pre-processing array for performing pre-processing of real time sensor data streams and reducing power consumption of an overall system, the configurable pre-processing array comprising:
a plurality of first processing units in a first processing layer for processing real time sensor data streams, the first processing units each configured to execute one or more first processing layer instructions from a main processor; and
a plurality of second processing units in a second processing layer for processing output data generated by the first processing layer, the second processing units each configured to execute one or more second processing layer instructions from the main processor;
wherein a first one of the second processing units comprises circuitry providing conditional data routing to one or more of the following: memory, a peer second processing unit, and a processing unit at a third processing layer, and the conditional data routing is based on output data of the first one of the second processing units.

2. (canceled)

3. The configurable pre-processing array of claim 1, further comprising:
a shared memory accessible by the first processing layer, the second processing layer, and the third processing layer without interference from the main processor.

4. The configurable pre-processing array of claim 1, wherein one of the first processing units includes an address generator block, an instruction memory, a read and write arbitration block, working registers for storing intermediate results of the one or more first layer processing instructions, special function registers for communicating data, data routing, and an arithmetic logic unit case statement block.

5. The configurable pre-processing array of claim 1, wherein at least one of the first processing units is configured to:
perform a single-shot execution of instructions in an instruction memory in response to an enable signal; and
stall after the execution of the single shot execution of instructions until another enable signal is triggered.

6. The configurable pre-processing array of claim 1, wherein at least one of the first processing units comprises asynchronous logic which gates a clock of the asynchronous logic when the execution of the one or more first processing layer instructions is complete.

7. The configurable pre-processing array of claim 1, wherein at least one of the one or more second processing units comprises an interrupt and address generator for storing interrupt, jump, and return vectors in registers that a program counter uses for generating the program counter.

8. The configurable pre-processing array of claim 1, wherein at least one of the one or more second processing units comprises an interrupt and address generator having a program counter that is programmable by the output of an arithmetic logic unit of the second processing unit.

9. The configurable pre-processing array of claim 1, wherein at least one of the one or more first processing units each has a single arithmetic logic unit, at least the one or more second processing units each has two arithmetic logic units.

10. The configurable pre-processing array of claim 1, wherein one of the second processing units have two arithmetic logic units for processing two streams of data simultaneously.

11. The configurable pre-processing array of claim 1, further comprising:
a plurality of third processing units in the third processing layer for processing output data generated by the second processing layer, the third processing units each configured to execute one or more third processing layer instructions from the main processor.

12. The configurable pre-processing array of claim 11, wherein at least one of the third processing units each has three arithmetic logic units.

13. The configurable pre-processing array of claim 11, wherein the one of the third processing units is configured to join outputs of two arithmetic logic units.

14. (canceled)

15. (canceled)

16. (canceled)

17. The configurable pre-processing array of claim 1, wherein the array operates asynchronously without a shared clock signal among the processing units.

18. A method for pre-processing real time sensor data streams and reducing context switching of a main processor, the method comprising:
monitoring, by a plurality of first processing units in a first processing layer of a configurable pre-processing array, real time sensor data streams from a plurality of sensors in parallel according to one or more first processing layer instructions from the main processor; and
in response to detecting activity of interest in the real time sensor data streams by a first one of the first processing units, interrupting a second processing unit in a second processing layer and providing output data from the first one of the first processing units to the second processing unit in the second processing layer.

19. The method of claim 18, wherein monitoring the real time sensor data streams comprises applying a threshold to at least one of the real time sensor data streams.

20. The method of claim 18, further comprising:
processing the output data from the first one of the first processing units by a first one of the second processing units according to one or more second layer processing instructions from the main processor.

21. The method of claim 20, further comprising:
reading the output data from the first one of the processing units by the second processing unit in burst mode via a circular queue.

22. The method of claim 20, further comprising:
routing output data of the first one of the second processing units conditionally by a first one of the second processing units to one or more of the following: memory, a peer second processing unit, and a processing unit at a third processing layer, based on output data of the first one of the second processing units.

23. The method of claim 18, further comprising:
stalling one or more ones of the second processing units until one or more ones of first processing units detect activity of interest.

24. (canceled)

25. A method for pre-processing real time sensor data streams from networked sensors, the method comprising:
receiving, at a configurable pre-processing array assisting a main processor, frames or packets comprising real time sensor data streams originating from a plurality of sensors;
performing network layer processing on the frames or the packets, by a plurality of first processing units in a first processing layer of the configurable pre-processing array;
providing the real time sensor data streams from the first processing units to a plurality of second processing units in a second processing layer of the configurable pre-processing array;
processing the real time sensor data streams by the second processing units, each one of the second processing units executing one or more second processing layer instructions from a main processor; and
in response to detecting activity of interest in the real time sensor data, interrupting at least one of the third processing units in a third processing layer and providing output data of the second processing layer to the at least one of the third processing units.

26. The configurable pre-processing array of claim 1, wherein the first processing layer further comprises a circular queue at an output of one of the first processing units, wherein one of the second processing units fetches the output data directly from the first processing layer via the circular queue.

27. The configurable pre-processing array of claim 1, wherein each one of the plurality of first processing units is connected to a respective sensor interface.

28. The configurable pre-processing array of claim 27, wherein the respective sensor is a serial interface.

29. The configurable pre-processing array of claim 1, wherein the array is coupled to a battery-powered device.

30. The method of claim 22, further comprising:
stalling one or more ones of the third processing units until one or more ones of second processing units detect activity of interest.
